(19) United States
(12) Patent Application Publication
(10) Pub. No.: US 2015/0139608 A1
(43) Pub. Date: May 21, 2015

(54) METHODS AND DEVICES FOR EXPLORING DIGITAL VIDEO COLLECTIONS

(71) Applicants: Christian Theobalt, Saarbrucken (DE); Kwang In Kim, Saarbrucken (DE); Jan Kautz, London (GB); James Tompkin, London (GB)

(72) Inventors: Christian Theobalt, Saarbrucken (DE); Kwang In Kim, Saarbrucken (DE); Jan Kautz, London (GB); James Tompkin, London (GB)

(73) Assignee: Max-Planck-Gesellschaft zur Förderung der Wissenschaften e.V., Munich (DE)

(21) Appl. No.: 14/400,548

(22) PCT Filed: May 11, 2012
(86) PCT No.: PCT/EP2012/002035

§ 371 Date: Dec. 18, 2014

(51) Int. Cl. G11B 27/28; G06T 19/20; G11B 27/34; G06K 9/00; G11B 27/031

(52) U.S. Cl. CPC G11B 27/28; G06K 9/00758; G06K 9/00744; G11B 27/031; G11B 27/34; G06T 19/20; G06T 2219/20
USPC 386/241

(57) ABSTRACT

Approaches presented herein enable to the interactive exploration of digital videos. The videos can include digital videos that have casually been captured by consumer devices, such as mobile phone cameras, tablets, and the like. Robust methods and systems are presented that enable such digital videos to be explored in interesting and advantageous ways, including transitions and other such features.

### CROSS-REFERENCE TO RELATED CASES

This application is a national phase entry of, and claims priority to, PCT International application Number PCT/EP2012/002035, filed May 11, 2012, and entitled “Methods and Device for Exploring Sparse, Unstructured Digital Video Collections,” which is hereby incorporated herein in its entirety for all purposes.

### TECHNICAL FIELD OF THE INVENTION

The present invention relates to the interactive exploration of digital videos. More particularly, it relates to robust methods and a system for exploring a set of digital videos that have casually been captured by consumer devices, such as mobile phone cameras and the like.

### BACKGROUND

In recent years, there has been an explosion of mobile devices capable of recording photographs that can be shared on community platforms. Tools have been developed to estimate the spatial relation between photographs, or to reconstruct 3D geometry of certain landmarks if a sufficiently dense set of photos is available [SNAVELY, N., SEITZ, S. M., AND SZELISKI, R. 2006. Phototourism: exploring photo collections in 3D. ACM Trans. Graph 25, 835-846; GOESELE, M., SNAVELY, N., CURLESS, B., HOPPE, H., AND SEITZ, S. M. 2007. Multi-view stereo for community photocollections. In Proc. ICCV, 1-8; AGARWAL, S., SNAVELY, N., SIMON, I., SEITZ, S., AND SZELISKI, R. 2009. Building Rome in a day. In Proc. ICCV, 72-79; FRAHM, J.- M., GEORGEL, P., GALLUP, D., JOHNSON, T., RAGURAM, R., WU, C., JEN, Y.- H., DUNN, E., CLIPP, B., LAZEBNIK, S., AND POLLEFEYS, M. 2010. Building Rome on a cloudless day. In Proc. ECCV, 368-381]. Users can then interactively explore these locations by viewing the reconstructed 3D models or spatially transitioning between photographs. Navigation tools like Google Street View or Bing Maps also use this exploration paradigm and reconstruct entire street networks through alignment of purposefully captured imagery via additionally recorded localization and depth sensor data.

However, these photo exploration tools are ideal for viewing and navigating static landmarks, such as Notre Dame, but cannot convey the dynamics, liveliness, and spatio-temporal relationships of a location or an event like video data. Yet, there are no comparable browsing experiences for casually captured videos and their generation is still a challenge. Videos are not simply series of images, so straightforward extensions of image-based approaches do not enable dynamic and lively video tours. In reality, the nature of casually captured video is also very different from photos and prevents a simple extension of principles used in photography. Casually captured video collections are usually sparse and largely unstructured, unlike the dense photo collections used in the approaches mentioned above. This precludes a dense reconstruction or registration of all frames. Furthermore, the exploration paradigm needs to reflect the dynamic and temporal nature of video.

Since casually captured community photo and video collections stem largely from unconstrained environments, analyzing their connections and the spatial arrangement of cameras is a challenging problem.

Snavely et al. [SNAVELY, N., SEITZ, S. M., AND SZELISKI, R. 2006. Phototourism: exploring photo collections in 3D. ACM Trans. Graph. 25, 835-846] performed structure-from-motion on a set of photographs showing the same spatial location (e.g., searching for images of ‘Notre Dame’), in order to estimate camera calibration and sparse 3D scene geometry. The set of images is arranged in space such that spatially confined locations can be interactively navigated. Recent work has used stereo reconstruction from photo tourism data, path finding through images taken from the same location, and cloud computing to enable significant speed-up of reconstruction from community photo collections. Other work finds novel strategies to scale the basic concepts to larger image sets for reconstruction, including reconstructing geometry from frames of videos captured from the roof of a vehicle with additional sensors. However, these approaches cannot yield a full 3D reconstruction of a depicted environment if the video data is sparse.

It is therefore an object of the present invention to provide methods and a system for exploring a set of digital video that is robust and efficient.

### BRIEF SUMMARY

This object is achieved by the methods and the system according to the independent claims. Advantageous embodiments are defined in the dependent claims.

According to the invention, a videoscape is a data structure comprising two or more digital videos and an index indicating possible visual transitions between the digital videos.

The methods for preparing a sparse, unstructured digital video collection for interactive exploration provide an effective pre-filtering strategy for portal candidates, the adaptation of holistic and feature-based matching strategies to video frame matching and a new graph based spectral refinement strategy. The methods and device for exploring a sparse, digital video collection provide an explorer application that enables intuitive and seamless spatio-temporal exploration of a videoscape, based on several novel exploration paradigms.

### BRIEF DESCRIPTION OF THE FIGURES

The patent or application file contains at least one drawing executed in color. Copies of this patent or patent application publication with color drawing(s) will be provided by the Office upon request and payment of the necessary fee.

These and other aspects and advantages of the present invention will become more evident when studying the following detailed description and embodiments of the invention, in connection with the annexed drawings/images in which

FIG. 1 shows a videoscape formed from casually captured videos, and an interactively-formed path through it of individual videos and automatically-generated transitions.

FIG. 2 shows an overview of a videoscape computation: a portal between two videos is established as a best frame correspondence, a 3D geometric model is reconstructed for a given portal based on all frames in the database in the supporting set of the portal.

FIG. 3 shows an example of a mistakenly found portal after matching. Such errors are removed in a context refinement phase. Blue lines indicate the feature correspondences.

FIG. 4 shows examples of portal frame pairs: the first row shows the portal frames extracted from two different videos in the database, while the second row shows the corresponding matching portal frames from other videos. The number below each frame shows the index of the corresponding source video in the database.

FIG. 5 shows a selection of transition type examples for Scene 3, showing the middle frame of each transition sequence for both view change amounts. 1a) Slight view change with warp. 1b) Considerable view change with warp. 2a) Slight view change with full 3D—static. 2b) Considerable view change with full 3D—static. 3a) Slight view change with ambient point clouds. 3b) Considerable view change with ambient point clouds.

FIG. 6 shows mean and standard deviation plotted on a perceptual scale for the different transition types across all scenes.

FIG. 7 shows an example of a portal choice in the interactive exploration mode.

FIG. 8 shows an interface for the path planning workflow according to an embodiment of the invention.

### DETAILED DESCRIPTION

Systems for exploring a collection of digital videos according to the described embodiments have both on-line and off-line components. An offline component constructs the videoscape; a graph capturing the semantic links within a database of casually captured videos. The edges of the graph are videos and the nodes are possible transition points between videos, so-called portals. The graph can be either directed or undirected, the difference being that an undirected graph allows videos to play backwards. If necessary, the graph can maintain temporal consistency by only allowing edges to portals forward in time. The graph can also include portals that join a single video at different times, i.e. a loop within a video. Along with the portal nodes, one may also add nodes representing the start and end of each input video. This ensures that all connected video content is navigable. The approach of the invention is equally suitable for indoor and outdoor scenes.

An online component provides interfaces to navigate the videoscape by watching videos and rendering transitions between them at portals.

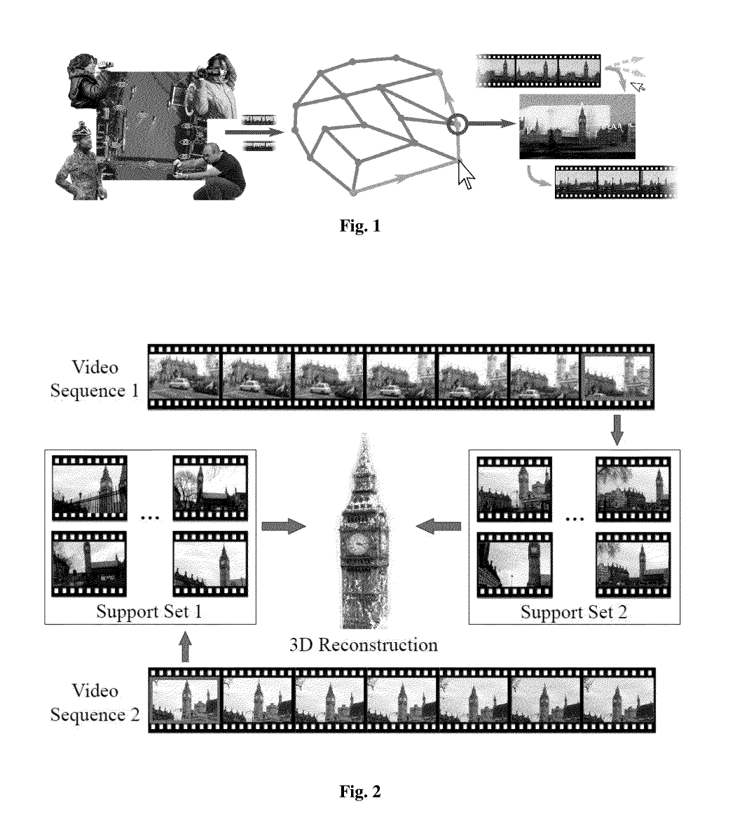

FIG. 1 shows a videoscape formed from casually captured videos, and an interactively-formed path through it of individual videos and automatically-generated transitions. A video frame from one such transition is shown here: a 3D reconstruction of Big Ben automatically formed from the frames across videos, viewed from a point in space between cameras and projected with video frames.

The edges of the videoscape graph structure are video segments and the nodes mark possible transition points (portals) between videos. The opposite is also possible, where a node represents a video and an edge represents a portal.

Portals are automatically identified from an appropriate subset of the video frames, as there is often great redundancy in videos. The portals (and the corresponding video frames) are then processed to enable smooth transitions between videos. The videoscape can be explored interactively by playing video clips and transitioning to other clips when a portal arises. When temporal context is relevant, temporal awareness of an event may be provided by offering correctly ordered transitions between temporally aligned videos. This yields a meaningful spatio-temporal viewing experience of large, unstructured video collections. A map-based viewing mode lets the virtual explorer choose start and end videos, and automatically find a path of videos and transitions that join them. GPS and orientation data is used to enhance the map-view when available. The user can assign labels to landmarks in a video, which are automatically propagated to all videos. Furthermore, images can be given to the system to define a path, and the closest matches through the videoscape are shown. To enhance the experience when transitioning through a portal, different video transition modes may be employed, with appropriate transitions selected based on the preference of participants in a user study.

Input to the inventive system is a database of videos. Each video may contain many different shots of several locations. Most videos are expected to have at least one shot that shows a similar location to at least one other video. Here the inventors intuit that people will naturally choose to capture prominent features in a scene, such as landmark buildings in a city. Videoscape construction commences by identifying possible portals between all pairs of video clips. A portal is a span of video frames in either video that shows the same physical location, possibly filmed from different viewpoints and at different times. In practice, a portal may be represented by a single pair of portal frames from this span, one frame from each video, through which a visual transition to the other video can be rendered (cf. FIG. 2). More particularly, for each portal, there may be 1) a set of frames representing the portal support set, and their index referencing the source video and frame number; 2) 2D feature points and correspondences for each frame in the support set; 3) a 3D point cloud; 4) accurate camera intrinsic parameters (e.g., focal length) and extrinsic parameters (e.g., positions, orientations), recovered using computer vision techniques and not from sensors, for all video frames from each constituent video within a temporal window of the portal. Parameters are accurate such that convincing re-projection onto geometry is possible; 5) a 3D surface reconstructed from the 3D point cloud; and 6) a set of textual labels describing the visual contents present in that portal. Each video in the videoscape may optionally have sensor data giving the position and orientation of every constituent video frame (not just around portals), captured by e.g., satellite positioning (e.g., GPS), inertial measurement units (IMU), etc. This data is separate from 4). Each video in the videoscape also optionally has stabilization data giving the required position, scale and rotation parameters to stabilize the video.

In addition to portals, all frames across all videos that broadly match and connect with these portal frames may be identified. This produces clusters of frames around visual targets, and enables 3D reconstruction of the portal geometry. This cluster may be termed the support set for a portal. For a portal, the support set can contain any frames from any video in the videoscapes, i.e., for a portal connecting videos A and B, the corresponding support set can contain a frame coming from a video C. All the frames mentioned above, i.e., all the frames considered in the videoscape construction, are those selected from videos based on either (or a combination of) optical flow, integrated position and rotation sensor data from e.g., satellite positioning, IMUs, etc., or potentially, any other key-frame selection algorithm.

After a portal and its corresponding supporting set have been identified, the portal geometry may be reconstructed as a 3D model of the environment.

FIG. 2 shows an overview of videoscape computation: a portal between two videos is established as the best frame correspondence, a 3D geometric model is reconstructed for a given portal based on all frames in the database in the supporting set of the portal. From this a video transition is generated as a 3D camera sweep combining the two videos (e.g., FIG. 1 right).

First, candidate portals are identified by matching suitable frames between videos that allow to smoothly move between them. Out of these candidates, the most appropriate portals are selected and the support set is finally deduced for each of them.

Naively matching all frames in the database against each other is computationally prohibitive. In order to select just enough frames per video such that all visual content is represented and all possible transitions are still found, optical flow analysis may be used which provides a good indication of the camera motion and allows finding appropriate video frames that are representative of the visual content. Frame-to-frame flow is analyzed, and one frame may be picked every time the cumulative flow in x (or y) exceeds 25% of the width (or height) of the video; that is, whenever the scene has moved 25% of a frame. This sampling strategy reduces unnecessary duplication in still and slow rotating segments. The reduction in the number of frames over regular sampling is content dependent, but in data sets tested by the inventors this flow analysis picks approximately 30% fewer frames, leading to a 50% reduction in computation time in subsequent stages compared to sampling every 50th frame (a moderate trade-off between retaining content and number of frames). The inventors compared the number of frames representing each scene for the naïve and the improved sampling strategy for a random selection of one scene from 10 videos. On average, for scene overlaps that were judged to be visually equal, the flow-based method produces 5 frames, and the regular sampling produces 7.5 frames per scene. This indicates that the pre-filtering stage according to the invention extracts frames more economically while maintaining a similar scene content sampling. With GPS and orientation sensor data provided, candidate frames that are unlikely to provide matches may further be culled. However, even though sensor fusion with a complementary filter is performed, culling should be done conservatively as sensor data is often unreliable. This allows processing datasets four times larger at the same computational cost.

In the holistic matching phase, the global structural similarity of frames is examined based on spatial pyramid matching. Bag-of-visual-word-type histograms of SIFT features with a standard set of parameters (#pyramid levels=3, codebook size=200) are used. The resulting matching score between each pair of frames is compared and pairs with scores higher than a threshold TH are discarded. The use of a holistic match before the subsequent feature matching has the advantage of reducing the overall time complexity, while not severely degrading matching results. The output from the holistic matching phase is a set of candidate matches (i.e., pairs of frames), some of which may be incorrect. Results may be improved through feature matching, and local frame context may be matched through the SIFT feature detector and descriptor. After running SIFT, RANSAC may be used to estimate matches that are most consistent according to the fundamental matrix.

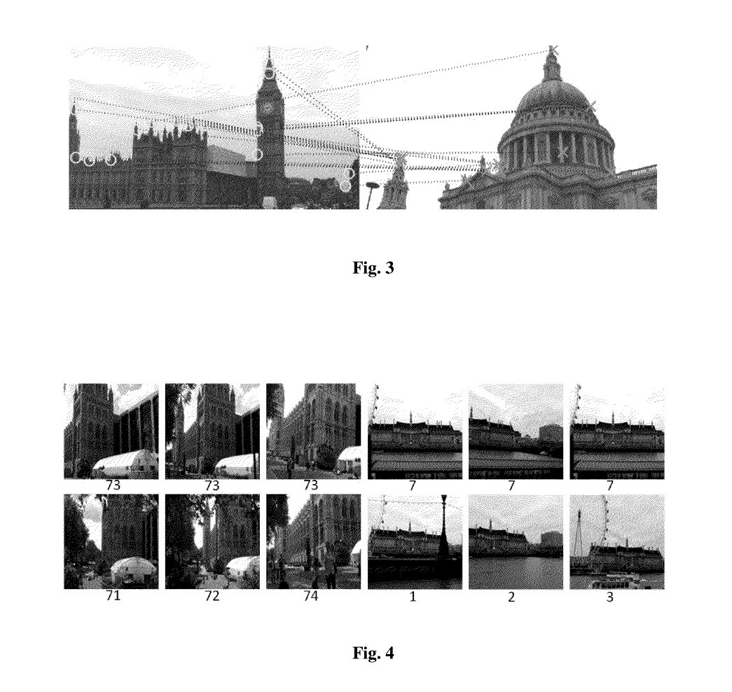

The output of the feature matching stage may still include false positive matches; for instance, FIG. 3 shows such an example of incorrect matches, which are hard to remove using only the result of pairwise feature matching. In preliminary experiments, it was observed that when simultaneously examining more than two pairs of frames, correct matches are more consistent with other correct matches than with incorrect matches. As an example, when frame I1 correctly matches frame 12, and frame 12 and 13 form another correct match, then it is very likely that I1 also matches 13. For incorrect matches, this is less likely.

This context information may be exploited to perform a novel graph-based refinement of the matches to prune false positives. First a graph representing all pairwise matches (nodes are frames and edges connect matching frames) is built. Each edge is associated with a real valued score representing the match's quality:

$$k ( I , J ) = \frac{2 \vert ℳ ( I , J ) \vert}{\vert S ( I ) \vert + \vert S ( J ) \vert} , \qquad ( 1 )$$

where I and J are connected frames, S(I) is the set of features (SIFT descriptors) calculated from frame I and M(I; J) is the set of feature matches for frames I and J. To ensure that the numbers of SIFT descriptors extracted from any pair of frames (I₁ and I₂) are comparable, all frames are scaled such that their heights are identical (480 pixels). Intuitively, k(•, •) F×F→>[0, 1] is close to 1 when two input frames contain common features and are similar.

Given this graph, spectral clustering [von Luxburg 2007] is run (taking the k first eigenvectors with eigenvalues >T_{I}, T_{I}=0.1) and connections between pairs of frames that span different clusters are removed. This effectively removes incorrect matches, such as in FIG. 3, since, intuitively speaking, spectral clustering will assign frames that are well inter-connected to the same cluster.

The matching and refinement phases may produce many multiple matching portal frames (Iᵢ; Iⱼ) between two videos. However, not all portals necessarily represent good transition opportunities. A good portal should exhibit good features matches as well as allow for a non-disorientating transition between videos, which is more likely for frame pairs shot from similar camera views, i.e., frame pairs with only small displacements between matched features. Therefore, only the best available portals are retained between a pair of video clips. To this end, the metric from Eq. 1 may be enhanced to favor such small displacements and the best portal may be defined as the frame pair (Iᵢ; Iⱼ) that maximizes the following score:

$$Q ( {I}_{i} , {I}_{j} ) = γ k ( {I}_{i} , {I}_{j} ) + \frac{( max ( 𝒟 ( {I}_{i} ) , 𝒟 ( {I}_{j} ) ) - \frac{{‖ M ( {I}_{i} , {I}_{j} ) ‖}_{F}}{‖ ℳ ( {I}_{i} , {I}_{j} ) ‖} )}{max ( 𝒟 ( {I}_{i} ) , 𝒟 ( {I}_{j} ) )} , \qquad ( 2 )$$

where D(•) is the diagonal size of a frame, M(•; •) is the set of matching features, M is a matrix whose rows correspond to feature displacement vectors, ∥•∥ F is the Frobenius norm, and γ is the ratio of the standard deviations of the first and the second summands excluding γ. FIG. 4 shows examples of identified portals. For each portal, the support set is defined as the set of all frames from the context that were found to match to at least one of the portal frames. Videos with no portals are not included in the videoscape.

In order to provide temporal navigation, frame-exact time synchronization is performed. Video candidates are grouped by timestamp and GPS data if available, and then their audio tracks are synchronized [KENNEDY L. and NAAMAN M. 2009. Less talk, more rock: automated organization of community-contributed collections of concert videos. In Proc. Of WWW, 311-320]. Positive results are aligned accurately to a global clock while negative results are aligned loosely by their timestamps. This information may be used later on to optionally enforce temporal coherence among generated tours and to indicate spatio-temporal transition possibilities to the user.

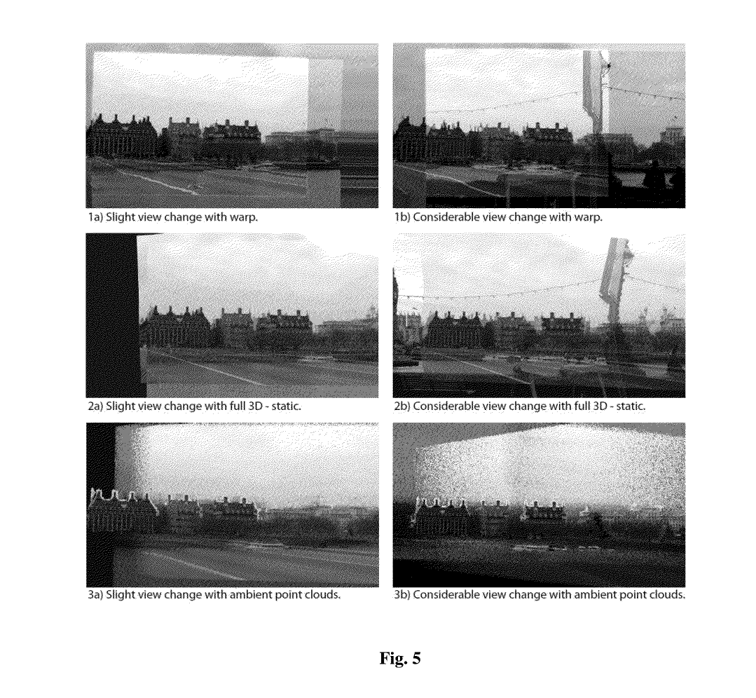

FIG. 5 shows key types of transitions between different digital videos. In order to visually transition from one video to the next, the method according to the invention supports seven different transition techniques: a cut, a dissolve, a warp and several 3D reconstruction camera sweeps. The cut jumps directly between the two portal frames. The dissolve linearly interpolates between the two videos over a fixed length. The warp cases and the 3D reconstructions exploit the support set of the portal.

First, an off-the-shelf structure from-motion (SFM) technique is employed to register all cameras from each support set. Alternatively, an off-the-shelf KLT based camera tracker may be used to find camera poses for frames in a four second window of each video around each portal.

Given 2D image correspondences from SFM between portal frames, the warp transition may be computed an as-similar-as-possible moving-least-squares (MLS) transform [SCHAEFER, S., MCPHAIL, T. and WARREN, J. 2006. Image deformation using moving least squares. ACM Trans. Graphics (Proc. SIGGRAPH) 25, 3, 533-540]. Interpolating this transform provides the broad motion change between portal frames. On top of this, individual video frames are warped to the broad motion using the (denser) KLT feature points, again by an as-similar-as possible MLS transform. However, some ghosting still exists, so a temporally-smoothed optical flow field is used to correct these errors in a similar way to Eisemann et al. 2008 (“Floating Textures”. Computer Graphics Forum, Proc. Eurographics 27, 2, 409-418). Preferably, all warps are precomputed once the videoscape is constructed. The four 3D reconstruction transitions use the same structure from-motion and video tracking results.

Multi-view stereo may be performed on the support set to reconstruct a dense point cloud of the portal scene. Then, an automated clean-up may be performed to remove isolated clusters of points by density estimation and thresholding (i.e., finding the average radius to the k-nearest neighbors and thresholding it). The video tracking result may be registered to the SFM cameras by matching screen-space feature points.

Based on this data, a plane transition may be supported, where a plane is fitted to the reconstructed geometry, and the two videos are projected and dissolved across the transition. Further an ambient point cloud-based (APC) transition [GOESELE, M. ACKERMANN, J., FUHRMANN, S., HAUBOLD, C., KLOWSKY, R., and DARMSTADT, T. 2010. Ambient point clouds for view interpolation. ACM Trans. Graphics (Proc. SIGGRAPH) 29, 95:1-95:6] may be supported, which projects video onto the reconstructed geometry and uses APCs for areas without reconstruction.

Two further transitions require the geometry to be completed using Poisson reconstruction and an additional background plane placed beyond the depth of any geometry, such that the camera's view is covered by geometry. With this, a full 3D—dynamic transition may be supported, where the two videos are projected onto the geometry. Finally, a full 3D—static transition may be supported, where only the portal frames are projected onto the geometry. This mode is useful when camera tracking is inaccurate due to large dynamic objects or camera shake. It provides a static view but without ghosting artifacts. In all transition cases, dynamic objects in either video are not handled explicitly, but dissolved implicitly across the transition.

Ideally, the motion of the virtual camera during the 3D reconstruction transitions should match the real camera motion shortly before and after the portal frames of the start and destination videos of the transition, and should mimic the camera motion style, e.g., shaky motion. To this end, the camera poses of each registered video may be interpolated across the transition. This produces convincing motion blending between different motion styles.

Certain transition types are more appropriate for certain scenes than others. Warps and blends may be better when the view change is slight, and transitions relying on 3D geometry may be better when the view change is considerable. In order to derive criteria to automatically choose the most appropriate transition type for a given portal, the inventors conducted a user study, which asked participants to rank transition types by preference. Ten pairs of portal frames were chosen representing five different scenes. Participants ranked the seven video transition types for each of the ten portals.

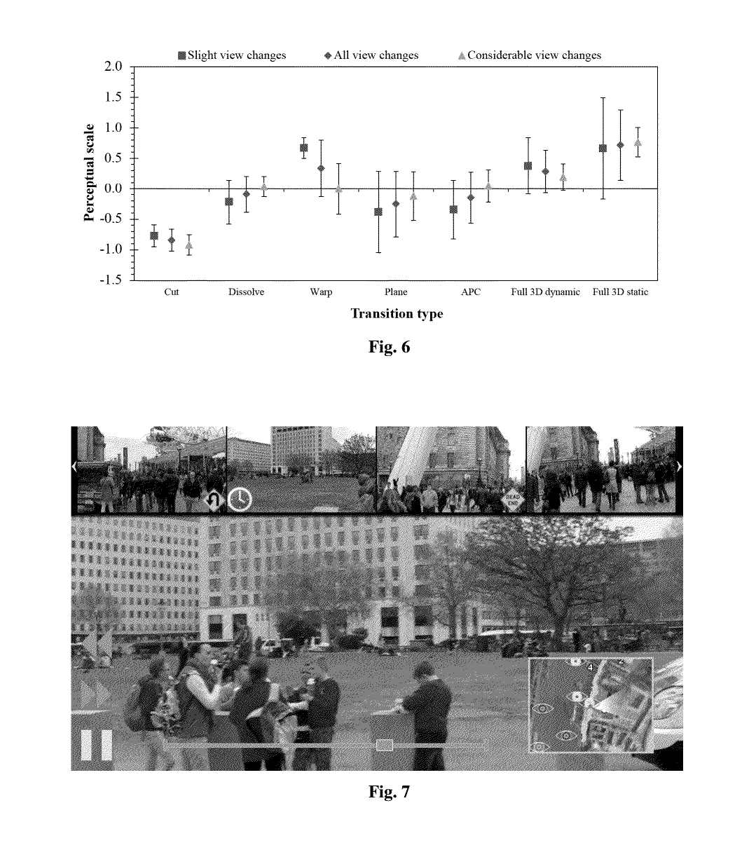

FIG. 6 shows mean and standard deviation plotted on a perceptual scale for the different transition types across all scenes. The results show that there is an overall preference for the static 3D transition. 3D transitions where both videos continued playing were preferred less, probably due to ghosting which stems from inaccurate camera tracks in the difficult shaky cases. The warp is preferred for slight view changes. The static 3D transition is preferred for considerable view changes. Hence, the system according to the invention employs a warp if the view rotation is slight, i.e. less than 10°. The static 3D transition is used for considerable view changes. The results of the user study also show that a dissolve is preferable to a cut. Should any portals fail to reconstruct, the inventive system will preferably fall back to a dissolve and not a cut.

Once the off-line construction of the videoscape has finished, it can be interactively navigated in three different modes. An interactive exploration mode allows casual exploration of the database by playing one video and transitioning to other videos at portals. These are automatically identified as they approach in time, and can be selected to initialize a transition. An overview mode allows visualizing the videoscape from the graph structure formed by the portals. If GPS data is available, the graph can be embedded into a geographical map indicating the spatial arrangements of the videoscape (FIG. 1a). A tour can be manually specified by selecting views from the map, or by browsing edges as real-world traveled paths. A third mode is available, in which images of desirable views are presented to the system (personal photos or image from the Web). The videoscape exploration system of the invention matches these against the videoscape and generates a graph path that encompasses the views. Once the path is found, a corresponding new video is assembled with transitions at portals.

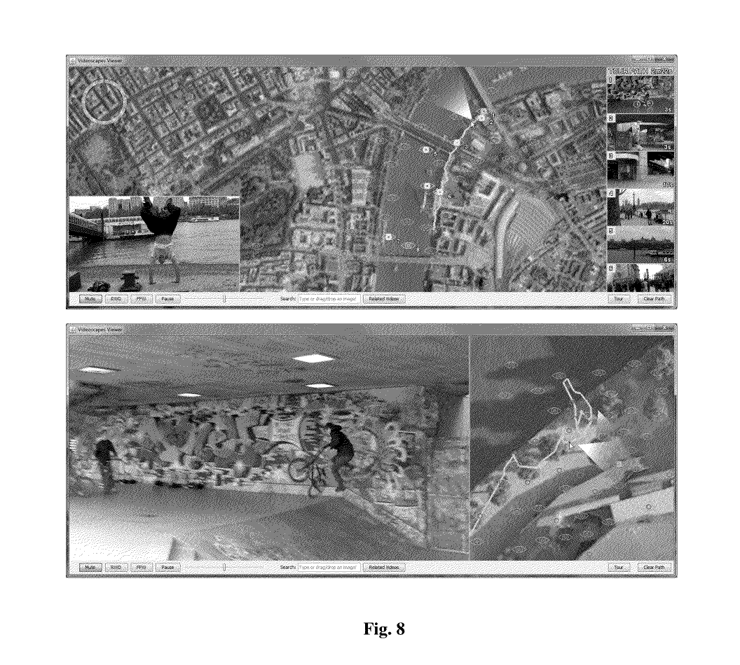

The inventors have developed an explorer application (FIGS. 7 and 8) which exploits the videoscape data structure and allows seamless navigation through sets of videos. Three workflows are provided for interacting with the videoscape, and the application itself seamlessly transitions via animations to accommodate these three ways of working with the data. This important aspect maintains the visual link between the graph and its embedding and the videos through transitions, and helps the viewer from becoming lost. While the system is foremost interactive, it can save composed video tours with optional stabilization to correct hand-held shake.

FIG. 7 shows an example of a portal choice in the interactive exploration mode. The mini-map follows the current video view cone in the tour. Time synchronous events are highlighted by the clock icon, and road sign icons inform of choices that return to the previous view and of choices that lead to dead ends in the videoscape.

In interactive exploration mode, as time progresses and a portal is near, the viewer is notified with an unobtrusive icon. If they choose to switch videos at this opportunity by moving the mouse, a thumbnail strip of destination choices smoothly appears asking “what would you like see next?” Here, the viewer can pause and scrub through each thumbnail as video to scan the contents of future paths. With a thumbnail selected, the system according to the invention generates an appropriate transition from the current view to a new video. This new video starts with the current view from a different spatio-temporal location, and ends with the chosen destination view. Audio is cross-faded as the transition is shown, and the new video then takes the viewer to their chosen destination view. This paradigm of moving between views of scenes is applicable when no other data beyond video is available (and so one cannot ask “where would you like to go next?”), and this forms the baseline experience.

Small icons are added to the thumbnails to aid navigation. A clock is shown when views are time-synchronous, and represents moving only spatially but not temporally to a different video. If a choice leads to a dead end, or if a choice leads to the previously seen view, commonly understood road sign icons may be added as well. Should GPS and orientation data be available, a togglable mini-map may be added, which displays and follows the view frustum in time from overhead.

FIG. 8 shows, at the top, an interface for the path planning workflow according to one embodiment of the invention. A tour has been defined, and is summarized in the interactive video strip to the right. An interface for the video browsing workflow is shown at the bottom. Here, the video inset is resized to expose as much detail as possible and alternative views of the current scene are shown as yellow view cones.

At any time, the mini-map can be expanded to fill the screen, and the viewer is presented with a large overview of the videoscape graph embedded into a globe [BELL, D., KUEHNEL, F., MAXWELL C., KIM, R., KASRAIE, K. GASKINS, T. HOGAN T., and COUGHLAN, J. 2007. NASA, World Wind: Opensource GIS for mission operations. In Proc. IEEE Aerospace Conference, 1-9] (FIG. 8, top). In this overview mode, eye icons are added to the map to represent portals. The geographical location of the eye is estimated from converging sensor data, so that the eye is placed approximately at the viewed scene. As a videoscape can contain hundreds of portals, the density of the displayed eyes may be adaptively changed so that the user is not overwhelmed. Eyes are added to the map in representative connectivity order, so that the most connected portals are always on display. When hovering over an eye, images of views that constitute the portal may be inlayed, along with cones showing where these views originated. The viewer can construct a video tour path by clicking eyes in sequence. The defined path is summarized in a strip of video thumbnails that appears to the right. As each thumbnail can be scrubbed, the suitability of the entire planned tour can be quickly assessed. Additionally, the inventive system can automatically generate tour paths from specified start and end points.

The third workflow is fast geographical video browsing. Real-world traveled paths may be drawn onto the map as lines. When hovering over a line, the appropriate section of video is displayed along with the respective view cones. Here, typically the video is shown side-by-side with the map to expose detail; though the viewer has full control over the size of the video should they prefer to see more of the map (FIG. 8, bottom). As time progresses, portals are identified by highlighting the appropriate eye and drawing smaller secondary view cones in yellow to show the position of alternative views. By clicking when the portal is shown, the view is appended to the current tour path. Once a path is defined by either method, the large map then returns to miniature size and the full-screen interactive mode plays the tour. This interplay between the three workflows allows for fast exploration of large videoscapes with many videos, and provides an accessible non-linear interface to content within a collection of videos that may otherwise be difficult to penetrate.

The search and browsing experience can be augmented by providing, in a video, semantic labels to objects or locations. For instance, the names of landmarks allow keyword-based indexing and searching. Viewers may also share subjective annotations with other people exploring a videoscape (e.g., “Great cappuccino in this café”).

The videoscapes according to the invention provide an intuitive, media-based interface to share labels: During the playback of a video, the viewer draws a bounding box to encompass the object of interest and attaches a label to it. Then, corresponding frames {Iᵢ} are retrieved by matching feature points contained within the box. As this matching is already performed and stored during videoscape computation for portal matching, this process reduces to a fast search. For each frame Iᵢ, the minimal bounding box containing all the matching key-points is identified as the location of the label. These inferred labels are further propagated to all the other frames

Finally, the viewer may be allowed to submit images to define a tour path. Image features are matched against portal frame features, and candidate portal frames are found. From these, a path is formed. A new video is generated in much the same way as before, but now the returned video is bookended with warps from and to the submitted images.

In summary, the videoscapes according to the invention provide a general framework for organizing and browsing video collections. This framework can be applied in different situations to provide users with a unique video browsing experience, for example regarding a bike race. Along the racetrack, there are many spectators who may have video cameras. Bikers may also have cameras, typically mounted on the helmet or the bike handle. From this set of unorganized videos, videoscapes may produce an organized virtual tour of the race: the video tour can show viewpoint changes from one spectator to another, from a spectator to a biker, from a biker to another biker, and so on. This video tour can provide both vivid first-person view experience (through the videos of bikers) and stable and more overview-like, third-person view of videos (through the videos of spectators). The transitions between these videos are natural and immersive since novel views are generated during the transition. This is unlike the established method of overlapping completely unrelated views as exercised in broadcasting systems. Videoscapes can exploit time stamps for the videos for synchronization, or exploit the audio tracks of videos to provide synchronization.

Similar functionality may be used in other sports, e.g., ski racing, where video footage may come from spectators, the athlete's helmet camera and possibly additional TV cameras. Existing view-synthesis systems used in sports footage, e.g., Piero BBC/Red Bee Media sports casting software, require calibration and set scene features (pitch lines), and do not accommodate unconstrained video input data (e.g., shaky, handheld footage). They also do not provide interactive experiences or a graph-like data structure created from hundreds or thousands of heterogeneous video clips, instead working only on a dozen cameras or so.

The videoscape technology according to the invention may also be used to browse and possibly enhance one's own vacation videos. For instance, if I visited London during my vacation, I could try to augment my own videos with a videoscape of similar videos that people placed on a community video platform. I could thus add footage to my own vacation video and build a tour of London that covers even places that I could not film myself. This would make the vacation video a more interesting experience.

In general, all the videoscape technology can be extended to entire community video collections, such as Youtube, which opens the path for a variety of additional potential applications, in particular applications that link up general videos with videos and additional information that people provide and share in social networks:

For instance, one could match a scene in a movie against a videoscape, e.g., to find another video in a community video database or on a social network platform like Facebook where some content in the scene was labeled, such as a nice cafe where many people like to have coffee. With the videoscape technology it is thus feasible to link existing visual footage with casually captured video from arbitrary other users, who may have added additional semantic information.

When watching a movie, a user could match a scene against a portal in the videoscape, enabling him to go on a virtual 3D tour of a location that was shown in the movie. He would be able to look around the place by transitioning into other videos of the same scene that were taken from other viewpoints at other times.

In another application of the inventive methods ands system, a videoscape of a certain event may be built that was filmed by many people who attended the event. For instance, many people may have attended the same concert and may have placed their videos onto a community platform. By building a videoscape from these videos, one could go on an immersive tour of the event by transitioning between videos that show the event from different viewpoints and/or at different moments in time.

In a further embodiment, the methods and system according to the invention may be applied for guiding a user through a museum. Viewers may follow and switch between first-person video of the occupants (or guides/experts). The graph may be visualized as video torches onto geometry of the museum. Wherever video cameras were imaging, a full-color projection onto geometry would light that part of the room and indicate to a viewer where the guide/expert was looking; however, the viewer would still be free to look around the room and see the other video torches of other occupants. Interesting objects in the museums would naturally be illuminated, as many people would be observing them.

In a further embodiment, the inventive methods and system may provide high-quality dynamic video-to-video transitions for dealing with medium-to-large scale video collections, for representing and discovering this graph on a map/globe, or for graph planning and interactively navigating the graph in demo community photo/video experience projects like Microsoft's Read/Write World (announced Apr. 15, 2011). Read/Write World attempts to geolocate and register photos and videos which are uploaded to it.

The videoscape may also be used to provide suggestions to people on how to improve their own videos. As an example, videos filmed by non-experts/consumers are often of lesser quality in terms of camera work, framing, scene composition or general image quality and resolution. By matching a private video against a videoscape, one could retrieve professionally filmed footage that has better framing, composition or image quality. A system could now support the user in many ways, for instance by making suggestions on how to refilm a scene, by suggesting to replace the scene from the private video with the video from the videoscape, or by improving image quality in the private video by enhancing it with the video footage from the videoscape.

What is claimed is:

1. A method for preparing a sparse, unstructured digital video collection for interactive exploration, comprising the steps of:
identifying at least one possible transition between a first digital video and a second digital video in the collection; and
storing the first digital video and the second digital video in a computer-readable medium, together with an index of the possible transition.

2. The method of claim 1, wherein the step of identifying comprises:
determining a similarity score representing a similarity between a frame of first frame of the first digital video and a second frame of the second digital video.

3. The method of claim 2, wherein at least one of the first frame or the second frame is selected based on at least one of: an optical flow between frames of the respective digital video, a geographic camera location for the frame, or camera orientation sensor data for the frame.

4. (canceled)

5. (canceled)

6. The method of claim 2, wherein the similarity is a global structural similarity between the first frame and the second frame.

7. The method of claim 2, wherein the similarity is determined based on spatial pyramid matching.

8. The method of claim 2, wherein the step of identifying further comprises matching features between the first frame and the second frame.

9. The method of claim 8, wherein the matching of features between the first frame and the second frame is based on a scale-invariant feature transform (SIFT) feature detector and descriptor.

10. The method of claim 9, wherein determining further comprises the step of estimating matches that are most consistent according to a fundamental matrix.

11. The method of claim 10, wherein the step of estimating utilizes a random sample consensus (RANSAC) algorithm.

12. The method of claim 1, wherein the step of identifying further comprises clustering similar frames of the first digital video and the second digital video.

13. The method of claim 12, wherein the clustering of similar frames comprises spectral clustering of a similarity graph for the frames of the first digital video and the second digital video.

14. The method of claim 13, wherein similarity is determined based on a number of feature matches.

15. The method according to claim 1, wherein the index references a first frame of the first digital video and the second frame of the second digital video.

16. The method of claim 1, further comprising the steps of
constructing a three-dimensional geometric model for the at least one possible visual transition; and
storing the geometric model in the computer-readable medium, together with the index.

17. The method of claim 16, wherein the three-dimensional geometric model for the at least one possible visual transition is constructed based on the index.

18. A method for exploring a sparse, unstructured video collection containing two or more digital videos and an index of possible visual transitions between pairs of videos, the method comprising the steps:
displaying at least a part of a first video of the unstructured video collection;
receiving a user input corresponding to a user;
displaying a visual transition from the first video to a second video of the unstructured video collection, based on the user input; and
displaying at least a part of the second video.

19. The method according to claim 18, further comprising the step of indicating possible visual transitions.

20. The method according to claim 18, wherein the possible visual transitions are displayed after a mouse move of the user.

21. The method according to claim 18, further comprising the step of displaying a clock.

22. The method according to claim 18, further comprising the step of displaying a map which displays and follows a view frustum in time from overhead, based on GPS and orientation data or data derived from computer-vision-based geometry reconstructions.

23. The method according to claim 22, further comprising the step of extending the map to display a large overview of a videoscape embedded into a globe.

24. The method according to claim 22, wherein the map comprises icons indicating a possible visual transition between digital videos.

25. The method according to claim 22, wherein a density of displayed icons is adaptively changed.

26. The method according to claim 22, further comprising the step of automatically generating tour paths from specified start and end points.

27. The method of claim 18, further comprising the steps of:
drawing real-world traveled paths onto the map as a set of lines; and
displaying an appropriate section of video when the user hovers over a corresponding line of the set of lines.

28. The method according to claim 27, wherein the tour paths are interactively assembled.

29. The method according to claim 18, further comprising the steps:
receiving an image submitted by a user;
finding candidate portal frames, based on the submitted image;
forming a path, based on the candidate portal frames; and
generating a new video bookended with warps from and to the submitted image.

30. The method according to claim 18, wherein a type of the visual transition is one of a cut, a dissolve, a warp, a plain transition, an ambient point cloud transition, a full 3D—dynamic transition, or a full 3D—static transition.

31. The method according to claim 30, wherein the type of visual transition is chosen automatically.

32. The method according to claim 30, wherein a warp transition is chosen automatically if a view rotation is slide.

33. The method to according to claim 30, wherein a static 3D transition is selected if a view changes considerably.

34. The method according to claim 30, wherein a dissolve transition is selected if a portal fails to reconstruct from insufficient context or bad camera tracking.

35. A non-transitory computer-readable storage medium including instructions that, when executed by at least one processor of a computing device, cause the computing device to:
store a videoscape, the videoscape including a set of edges, each edge of the set of edges comprising a respective digital video segment, the videoscape further including a set of nodes, each node of the set of nodes comprising a respective possible transition points between the digital video segments;
provide a first digital video segment for display; and
in response to a user input, provide a second digital video segment for display, the second digital video segment selected based at least in part upon a respective node corresponding to the user input.
